(19) United States
(12) Patent Application Publication
(10) Pub. No.: US 2011/0250470 A1
(43) Pub. Date: Oct. 13, 2011

(54) Brazed Object and Process for Brazing Two or More Parts

(75) Inventors: Thomas Hartmann, Altenstadt (DE); Dieter Nuetzel, Shanghai (CN)

(73) Assignee: Vacuumschmelze GmbH & Co. KG, Hanau (DE)

(21) Appl. No.: 13/082,772

(22) Filed: Apr. 8, 2011

(30) Foreign Application Priority Data
Apr. 8, 2010 (DE) 10 2010 016 367.8

(51) Int. Cl. B23K 1/16; B32B 15/00; B32B 15/01

(52) U.S. Cl. 428/679; 228/246; 228/249; 428/332; 428/457

(57) ABSTRACT

The invention provides a process for brazing two or three parts. A braze with a composition consisting of NiᵣₑₛCrₐB_{b}P_{c}Si_{d} with 20 atomic percent<a<22 atomic percent; 1.2 atomic percent≦b≦3.6 atomic percent; 12.5 atomic percent≦c≦14.5 atomic percent; 0 atomic percent≦d<1.5 atomic percent; incidental impurities≦0.5 atomic percent; and residual Ni is inserted between two or more parts to be joined to form a joint, the parts to be joined having a higher melting temperature than the braze. The joint is heated to a temperature of between 1020° C. and 1070° C. and cooled to form a brazed joint between the parts.

### CROSS REFERENCE TO RELATED APPLICATION

This application claims priority under 35 U.S.C. §119 to German Application No. 10 2010 016 367.8, filed Apr. 8, 2010, the entire content of which is hereby incorporated by reference.

### BACKGROUND

1. Field

Disclosed herein is a brazed object and a process for brazing two or more parts.

2. Description of Related Art

Soldering is a process for joining metallic or ceramic parts using a molten filler material referred to as solder. A distinction is made between soft solders and hard solders, or brazes, depending on the temperature at which the solder is processed. Soft solders are processed at temperatures below 450° C., while brazes are processed at temperatures above 450° C. Brazes are used in applications where high mechanical strength of the soldered joint and/or high mechanical strength at high operating temperatures is desired.

Parts made of stainless steel or of Ni and Co alloys are frequently joined together using Ni-based brazes which may also have a certain chromium content to improve corrosion resistance. In addition, these brazes may contain one or more of the metalloid elements silicon, boron and phosphorus, leading to a reduction in the melting temperature and consequently the processing temperature of the braze. These elements are also referred to as glass-forming elements. DE 10 2007 049 508 A1 discloses a Ni—C—P-based brazing foil.

Ni—Cr brazing alloys can be provided in the form of solder powders produced using atomizing processes, in the form of solder pastes in which the atomised powders are mixed with organic binding agents and solvents or in the form of a foil. Brazing foils can be produced in the form of ductile, at least partially amorphous foils by means of a rapid solidification process.

It is desirable to be able to produce a brazed joint reliably and for the joint to connect the parts reliably when in operation. In certain applications such as exhaust gas coolers where the object comes into contact with aggressive media it is also desirable for the solder seam to be sufficiently corrosion-resistant during operation to maintain its mechanical strength.

### SUMMARY

An object of embodiments disclosed herein is therefore to specify a brazed object with a joint which is more reliable in operation. A further object is to specify a process for the manufacture of a brazed object.

In one embodiment disclosed a brazed object comprising a first part and a second part. The first part is joined fast to the second part by a solder seam, the solder seam being produced with a braze with a composition consisting of NiᵣₑₛCrₐB_{b}P_{c}Si_{d} with 20 atomic percent<a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni. The loss in mass of the solder seam after ageing for 1000 hours at 70° C. in a corrosion medium with a pH value of <2 and SO₄²⁻ NO₃⁻ Cl⁻ ions is less than 0.08%.

This brazed object is thus reliable in operation as it has good corrosion resistance. It is possible to achieve this lower loss in solder seam mass in these conditions by selecting the soldering temperature. In one embodiment the solder seam is produced at a temperature of between 1020° C. and 1070° C., preferably between 1030° C. and 1060° C.

By selecting the soldering temperature, it is also possible to achieve good mechanical strength in the solder seam and good mechanical stability. In one embodiment the solder seam has a tensile strength greater than 200 MPa as a result of which in applications where the object is exposed to strong vibrations and impacts during use, such as in a vehicle, for example, the brazed object disclosed herein remains mechanically stable. Where the soldered joint is insufficiently strong, these conditions can cause the solder seam to become detached and leak and thus the complete failure of the object.

The brazed object disclosed herein can also have a stable and reliable leak tightness. This is important in applications such as heat exchangers and exhaust gas recirculation coolers where different media flowing through the component at different temperatures lead to thermal stresses. Good mechanical strength of the soldered joint prevents these thermal stresses from leading to the mechanical failure of the soldered joint or joints.

The solder seam between the two parts can also comprise elements originating from one or both of the parts as these elements are able to migrate from the parts into the solder seam during brazing. The composition of the solder seam may therefore differ from the composition of the braze.

The incidental impurities may comprise the elements iron, cobalt and/or carbon, the iron content being less than 1.0% by weight, the cobalt content being less than 1.0% by weight and the carbon content being less than 0.1% by weight.

In one embodiment the solder seam has intermetallic phases comprising Cr and P and/or B with a size d of 0 μm<d≦3 μm. The size of these phases in a ground solder seam can be measured by means of analysis using an optical or scanning electron microscope. The size of the individual grains of these intermetallic phases lies within this range, it being possible for the individual grains to be of different sizes.

An object with a solder seam of this composition and with phases of this size comprising Cr and P and/or B has better corrosion resistance than a solder seam with phases comprising Cr and P and/or B over 3 μm in size.

These remarks refer in particular to corrosion resistance against acid media. These media can have pH values of less than 2 and comprise ions such as SO₄²⁻ and/or NO₃⁻ and/or Cl⁻, for example. Such media may be present in the exhaust gas condensate of internal combustion engines, for example.

Corrosion resistance can be measured by the loss in mass of samples aged in such a medium at room temperature or a temperature similar to operating temperatures. Ageing times from 100 to 1000 hours can be used.

In one embodiment the intermetallic phases have a size d of 0<d≦2 μm. A reduction in maximum size from 3 μm to 2 μm can lead to a further improvement in corrosion resistance.

The intermetallic phases comprising Cr and P and/or B can be distributed across the entire thickness of the solder seam and can, in addition, be distributed evenly across the entire thickness of the solder seam. Increased homogeneity of distribution can lead to improved solder seam corrosion resistance.

In one embodiment the solder seam has a thickness of greater than 15 μm. This thickness of greater than 15 μm can occur at least one point. In a further embodiment the solder seam has a minimum thickness of greater than 15 μm.

If a round part is joined to a flat part, for example, the thickness of the solder seam between the round part and the flat part may be uneven because the gap between the round part and the flat part is itself uneven.

The first and second parts of the brazed object can be made of a chromium-containing stainless steel such as an austenitic stainless steel, a Ni alloy or a Co alloy.

The brazed object as disclosed in one of the preceding embodiments can be a heat exchanger or an exhaust gas recirculation cooler or a metallic particle filter.

Another embodiment provides a process for brazing two or more parts which comprises the following steps. A braze with a composition consisting of NiᵣₑₛCrₐB_{b}P_{c}Si_{d} with 20 atomic percent<a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni is inserted between two or more parts to be joined to form a joint. The parts to be joined have a higher melting temperature than the braze. The joint is heated to a temperature of between 1020° C. and 1070° C. and then cooled to form a brazed joint between the parts to be joined.

After cooling a solid solder seam is produced between the parts, joining them together by fusion. The temperature of between 1020° C. and 1070° C. to which the joint is heated is also known as the soldering temperature. A soldering temperature within this range permits the production of a brazed object with a corrosion-resistant and mechanically stable solder seam.

Furthermore, this solder can have intermetallic phases comprising Cr and P and/or B and a size d of 0 μm<d≦3 μm.

At soldering temperatures of above 1070° C., corrosion resistance drops, causing cavities to occur in the solder seam following corrosion testing or in aggressive media such as acid media. In addition, the size of intermetallic phases comprising Cr and P and/or B can increase to above 3 μm. At a soldering temperature of below 1020° C. the mechanical strength of the solder seam falls and a reliable mechanical joint between the parts is no longer produced.

The braze can be inserted in the form of an amorphous ductile foil or a paste. Ductile, at least partially amorphous brazing foils can be produced by means of rapid solidification processes. A solder paste can comprise solder powder mixed with organic binding agents or solvents. The solder powder can be produced using atomization processes.

The form of the braze can be chosen on the basis of the shape of the parts to be joined. For example, a brazing foil can be used to join two parts which nest one inside the other, such as pipes. The braze can be inserted between the parts by wrapping the foil around the inner part. A braze in the form of a paste can be used to apply one or more separate solder deposits to specific areas of a substrate by means of a mask.

In one embodiment the joint is heated to a temperature of between 1030° C. and 1060° C. This temperature range can further improve the mechanical, reliability of the joint or solder seam and the corrosion resistance of the solder seam.

The joint can be heated under hydrogen or a hydrogenous gas such as Ar4% H₂, under an inert gas such as argon or under a cracked gas. This prevents the creation of a vacuum during the brazing process.

In one embodiment the joint is heated in a continuous furnace. A continuous furnace can be used to advantage in the mass production of brazed objects since it offers shorter production times and lower production costs than a batch process. In a continuous furnace it is advantageous to be able to carry out brazing under hydrogen or inert gas in order to simplify the sealing of the furnace against the ambient atmosphere.

The invention also provides the use of a braze with a composition consisting of

NiᵣₑₛCrₐB_{b}P_{c}Si_{d}

with 20 atomic percent<a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni to join by fusion two or more parts made of austenitic stainless steel or a Ni alloy or a Co alloy or for brazing two or more parts of a heat exchanger, in particular an oil cooler, or an exhaust gas recirculation cooler or a metallic particle filter at a temperature of between 1020° C. and 1070° C.

### BRIEF DESCRIPTION OF THE DRAWINGS

Embodiments are explained in greater detail below with reference to the drawings.

FIG. 1 illustrates a brazed object in accordance with a first embodiment.

FIG. 2 illustrates a diagram representing the relationship between corrosion resistance and soldering temperature in brazed objects in accordance with a second embodiment.

FIG. 3 illustrates micrographs of objects brazed at temperatures of 1000° C., 1050° C., 1100° C. and 1150° C. after corrosion testing in accordance with a third embodiment.

FIG. 4 illustrates a diagram representing the relationship between corrosion resistance and soldering temperature in brazed objects in accordance with a fourth embodiment.

FIG. 5 illustrates a micrograph of a solder seam of a brazed object in accordance with a fifth embodiment.

FIG. 6 illustrates a micrograph of a solder seam of a brazed object in accordance with a sixth embodiment.

FIG. 7 illustrates micrographs of a solder seam of a brazed object in accordance with a seventh embodiment.

FIG. 8 illustrates a diagram representing the relationship between tensile strength and soldering temperature in brazed objects in accordance with an eighth embodiment.

### DETAILED DESCRIPTION OF SPECIFIC EMBODIMENTS

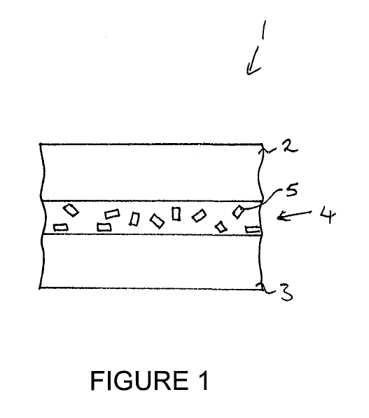

FIG. 1 illustrates a schematic representation of a brazed object 1 in accordance with a first embodiment.

The object 1 has a first part 2 and a second part 3 which are joined by fusion by a solder seam 4. In this embodiment the parts 2, 3 are made of stainless steel. In further embodiments the parts are made of an austenitic stainless steel or a Ni alloy or a Co alloy.

The solder seam 4 is produced with a braze with a composition consisting of NiᵣₑₛCrₐB_{b}P_{c}Si_{d} with 20 atomic percent<a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni. However, the overall composition of the solder seam 4 cannot correspond to the composition of the braze if the braze has reacted with elements of the parts 2, 3 or if elements from the parts 2, 3 have migrated to the braze during the brazing process and formed phases with the components of the braze.

The solder seam 4 has intermetallic phases 5 which comprise Cr, in particular at least 80% by weight Cr, and P and/or B and have a size d of 0 μm<d≦3 μm. The size of these intermetallic phases 5 can be measured in a ground solder seam by means of analysis using an optical or scanning electron microscope. The size of the individual grains of the intermetallic phases 5 can vary but lies within this range. The intermetallic phases comprising Cr and P and/or B are distributed across the entire thickness of the solder seam 4.

The brazed object 1 is produced with a braze which has a composition consisting of NiᵣₑₛCrₐB_{b}P_{c}Si_{d} with 20 atomic percent<a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni. The braze is provided in the form of an amorphous ductile foil and inserted between the first part 2 and the second part 3, thereby creating a joint from the first part 2, the brazing foil and the second part 3. The parts 2, 3 to be joined have a higher melting temperature than the braze.

The joint is heated to a soldering temperature of between 1020° C. and 1070° C., preferably 1030° C. and 1060° C., in a hydrogenous atmosphere and then cooled to form a brazed joint between the parts 2, 3, thereby connecting the first part 2 to the second part 3 by a solder seam 4.

A soldering temperature within the range of 1020° C. to 1070° C. permits the reliable production of a brazed object 1 with a corrosion-resistant and mechanically stable solder seam 4. Furthermore, this solder seam 4 can have intermetallic phases 5 containing Cr and P and/or B and a size d of 0 μm<d≦3 μm. In particular, the solder seam 4 has good corrosion resistance in aggressive media such as acid media.

### Example 1

First, a Ni-based brazing alloy with the composition Ni—Cr21-P8-Si0.5-B0.5 (% by weight) is produced as an amorphous soldering foil with a thickness of 30 μm using rapid solidification technology. This brazing foil is used to solder samples of stainless steel (in particular stainless steel 316L, 1.4404) in which a base plate is joined to two pipe sections at soldering temperatures of 1000° C., 1050° C., 1100° C. and 1150° C. in a vacuum for a soldering time of 15 minutes.

These samples are then aged in a corrosion medium with a pH value <2 and SO₄²⁻ NO₃⁻ Cl⁻ ions at 70° C. for a total period of 1000 h. The change in mass of the samples is recorded at 200 h intervals.

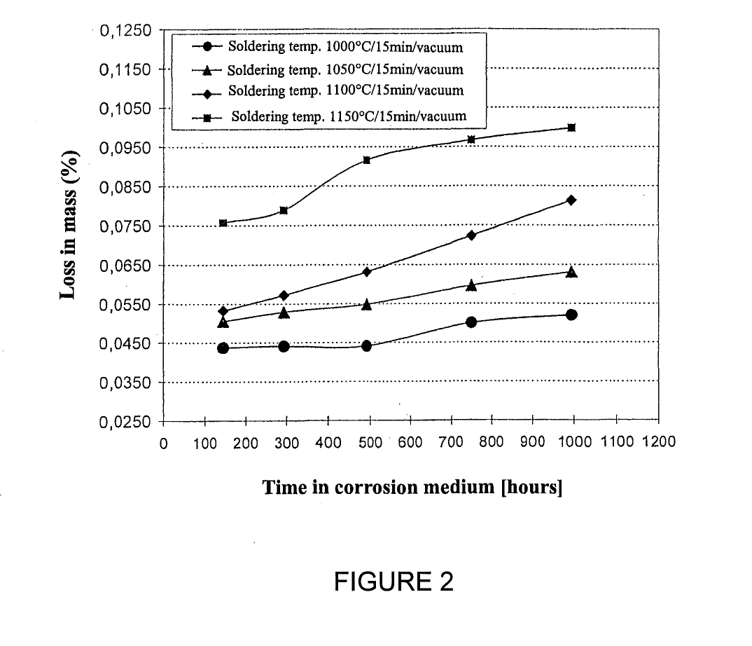

FIG. 2 illustrates the loss in mass of stainless steel samples joined with a brazing foil with the composition Ni—Cr21-P8-Si0.5-B0.5 (% by weight) at different soldering temperatures of 1000° C., 1050° C., 1100° C. and 1150° C. in relation to ageing time. The brazed samples joined at 1150° C. and 1100° C. illustrate a significantly greater loss in mass, which is synonymous with markedly greater corrosion, than the samples brazed at 1000° C. and 1050° C. The samples joined at the higher soldering temperatures of 1100° C. and 1150° C. also illustrate a greater rise in curve after 1000 h ageing, suggesting that corrosion is further advanced.

Better corrosion resistance corresponding to the lowest loss in solder sample mass is observed at soldering temperatures of 1050° C. and 1000° C.

### Example 2

First a Ni-based brazing alloy with the composition Ni—Cr21-P8-Si0.5-B0.5 (% by weight) is produced as an amorphous soldering foil with a thickness of 30 μm using rapid solidification technology. This brazing foil is used to solder samples of stainless steel (in particular stainless steel 316L, 1.4404) in which a base plate is joined to two pipe sections at soldering temperatures of 1000° C., 1050° C., 1100° C. and 1150° C. in a vacuum.

A corrosion test is then carried out. Prior to ageing the samples are cut up to give the corrosion medium as great a contact surface as possible in the area of the solder seams. Ageing then takes place in a corrosion medium with a pH value of <2 and SO₄²⁻ NO₃⁻ Cl⁻ ions at 70° C. over a total period of 1000 h. Following ageing the brazed stainless steel samples are prepared metallographically to evaluate the corrosion of the solder seams.

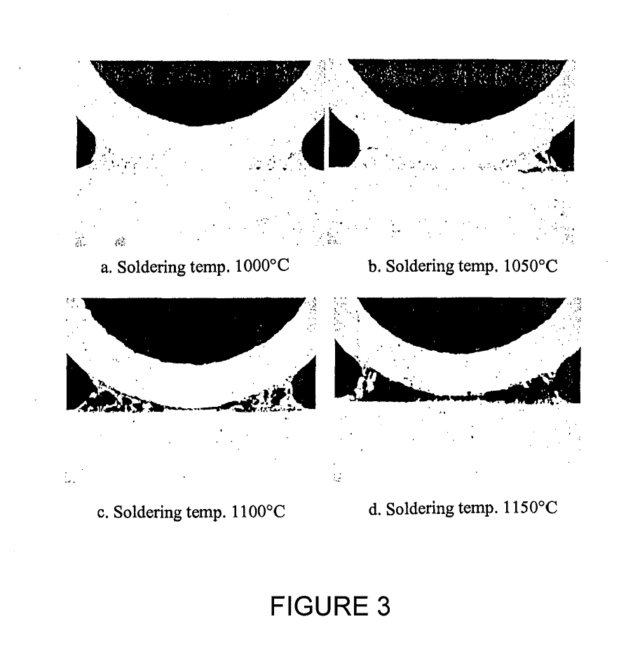

FIG. 3 illustrates a metallographic evaluation of the stainless steel samples brazed in a vacuum at various soldering temperatures produced with a brazing foil with the composition Ni—Cr21-P8-Si0.5-B0.5 (% by weight) after ageing in the corrosion medium for 1000 hours.

FIGS. 3a to 3d illustrate metallographic specimens from the soldering seams joined at soldering temperatures of 1000° C., 1050° C., 1100° C. and 1150° C. It is clear that the samples brazed at 1100° C. and 1150° C. in particular have undergone massive corrosion as evidenced by the black areas on the specimens. These black areas are areas of the solder seam dissolved by corrosion. Large areas of the solder seam have been significantly—at 1150° C. soldering temperature—and even completely dissolved by the corrosion medium. The joint is no longer mechanically stable or tight.

In the sample brazed at 1050° C. the solder seam illustrates only local corrosion as indicated by the black areas in the micrograph. In the sample brazed at 1000° C. no significant area of corrosion can be seen. Better corrosion resistance ensuring a stable, tight soldered joint over the entire period of use can be achieved at a soldering temperature <1100° C.

### Example 3

First a Ni-based brazing alloy with the composition Ni—Cr21-P8-Si0.5-B0.5 (% by weight) is produced as an amorphous soldering foil with a thickness of 35 μm using rapid solidification technology. This brazing foil is then used to solder samples of stainless steel (in particular stainless steel 3104; 1.4404) at soldering temperatures of 1000° C., 1050° C. and 1100° C. in a continuous furnace under hydrogen for a soldering time of 10 minutes. Parts of these solder samples are aged in a corrosion medium with a pH value <2 and SO₄²⁻ NO³⁻ Cl⁻ ions at 70° C. for a total period of 1000 hours. The change in mass of the samples is recorded at 200 h intervals.

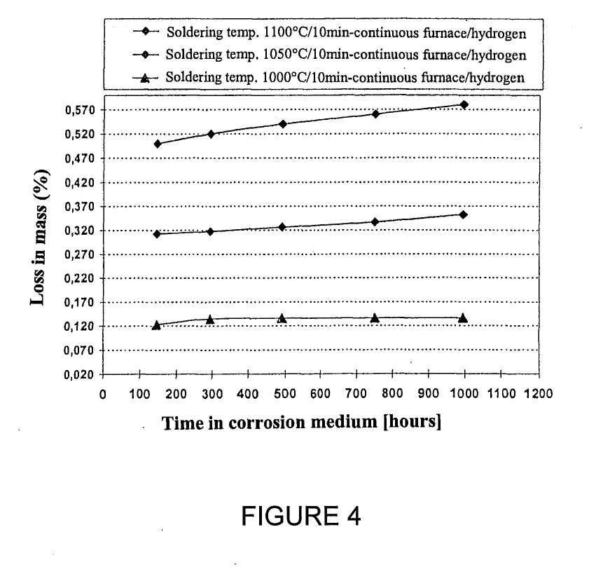

FIG. 4 illustrates the loss in mass of the stainless steel samples joined with a brazing foil with the composition Ni—Cr21-P8-Si0.5-B0.5 (% by weight) at the various soldering temperatures in relation to ageing time. An increased loss in mass is an indicator that the soldered joint is damaged and the long-term stability of the soldered joint is thus no longer ensured. The brazed samples joined at 1100° C. illustrate a significantly greater loss in mass—consistent with significantly more marked corrosion—than the samples brazed at temperatures of below 1100° C. Better corrosion resistance corresponding to the lowest loss in soldering sample mass is once again achieved at soldering temperatures of 1050° C. and 1000° C.

It is thus established that joint formation/microstructure within the solder seam is influenced by soldering temperature.

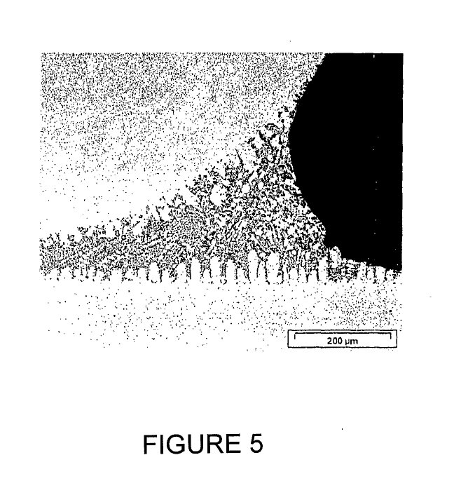

FIG. 5 illustrates the microstructure/phase formation of a brazed stainless steel sample produced with a braze foil with the composition Ni—Cr21-P8-Si0.5-B0.5 (% by weight), the object having been soldered for 10 minutes at 1000° C. under hydrogen in a continuous furnace.

The microstructure within the solder seams with Ni—Cr—P and Ni—Cr—Si—P brazes is characterised by the marked formation of intermetallic phases or brittle phases. While with Ni—Cr—B—Si brazes silicidic and boridic brittle phases occur only in the centre of the solder seam with wide solder gaps, with Ni—Cr—P—Si—B solders the entire solder seam is generally run through by various intermetallic phosphoridic phases as can be seen in FIG. 5.

One reason for the improved corrosion resistance of the samples soldered at temperatures of less than 1100° C. could lie in the formation of intermetallic phases with Cr and B and/or P, in particular a high chromium-containing phase which contains approx. 80% chromium and phosphorus and boron in addition to a metal content (Ni, Fe) of <10% by weight.

This phase clearly binds large amounts of chromium to a Cr—B/P compound. These relatively large amounts of bound chromium are therefore no longer available to improve corrosion resistance. In particular, the areas of the joint adjacent to these Cr—B/P phases could be significantly chromium-impoverished, thereby significantly weakening the corrosion resistance of these areas and making them susceptible to greater corrosion.

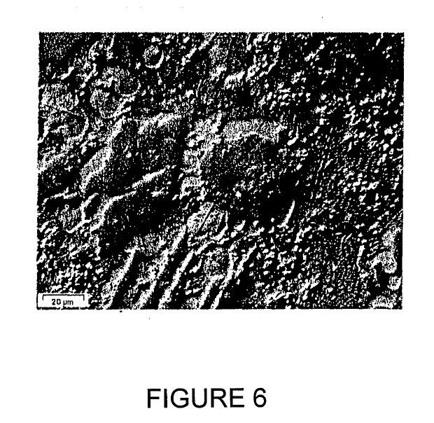

FIG. 6 illustrates the microstructure/phase formation of a brazed stainless steel sample produced with a brazing foil with the composition Ni—Cr21-P8-Si0.5-B0.5 (% by weight). This sample was brazed for 10 minutes at 1000° C. under hydrogen in a continuous furnace. The solder seam has finely distributed Cr—P/B brittle phases with a size of 1-2 μm.

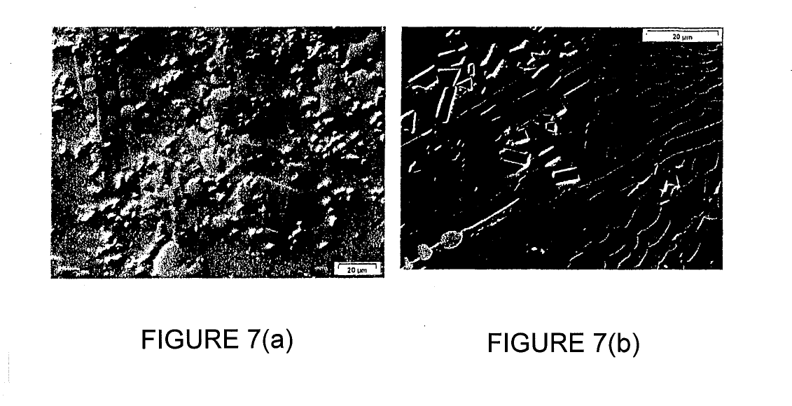

FIGS. 7a and 7b illustrate the microstructure/phase formation of the solder seam of a stainless steel sample joined with a brazing foil with the composition Ni—Cr21-P8-Si0.5-B0.5 (% by weight). The sample was soldered for 10 minutes at 1050° C. under hydrogen in a continuous furnace.

FIG. 7a illustrates distributed Cr—P/B brittle phases some of which are arranged in agglomerations with a size of between 3-6 μm. FIG. 7b illustrates a detailed view of an agglomeration of straight-edged Cr—B/P brittle phases, some of which are rectangular, with a size between 3-6 μm. FIG. 7 also illustrates these Cr—B/P phases which are significant in terms of corrosion as straight-edged and often rectangular structures, some of which are also arranged in agglomerations.

As the soldering temperature increases, this Cr—P/B phase appears to become coarser and to occupy a greater volume of the solder seam. Thus, for example, the typical size of these Cr—B/P brittle phases increases from 1-3 μm at a soldering temperature of 1000° C. (FIG. 6) to 3-6 μm at 1050° C. (FIG. 7). The increasing volume of this phase in conjunction with the coarser aspect leads to a greater percentage of bound chromium within the solder seam. This is associated with poorer corrosion resistance. For better corrosion resistance it would appear advantageous for this Cr—P/B phase to be as small as possible and not to exceed a size of approx. 3-6 μm.

### Example 4

A static tensile test is carried out to determine the mechanical strength of the soldered joints. The type of sample chosen is a butt-soldered tensile sample (DIN EN 12797:200 type 3) made of steel 316/1.4404. The samples are butt-soldered with a brazing foil with the composition Ni—Cr21-P8-Si0.5-B0.5 (% by weight) at different soldering temperatures with a soldering time of 30 minutes.

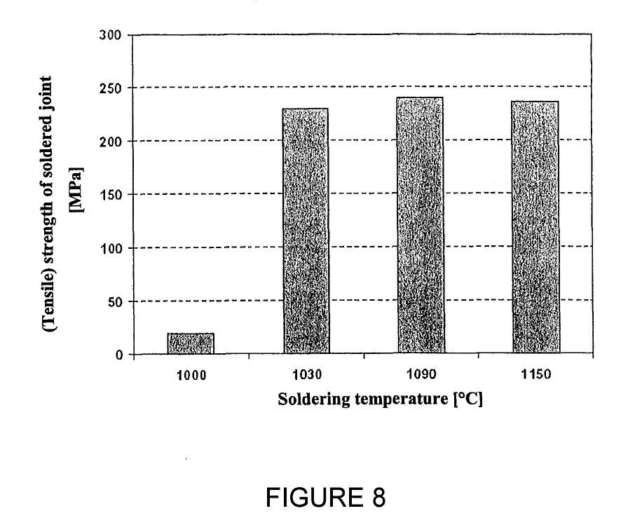

FIG. 8 represents in graphic form the measured tensile strength of these joints soldered at different soldering temperatures.

A soldering temperature of 1000° C. results in a tensile strength of less than 25 MPa which is insufficient for many technical applications. At soldering temperatures of 1030° C., 1090° C. and 1150° C. a tensile strength of above 200 MPa is achieved, with relatively stable values being achieved in this temperature range. Consequently, it is possible to ensure a long-term mechanically stable and tight connection if brazing is carried out with this composition at a temperature above 1020° C. or 1030° C.

The invention having been thus described with reference to certain specific embodiments and examples thereof, it will be understood that this is illustrative, and not limiting, of the appended claims.

1. A process for brazing two or more parts comprising:
inserting of a braze with a composition consisting of NiᵣₑₛCrₐB_{b}P_{c}Si_{d} with 20 atomic percent <a<22 atomic percent; 1.2 atomic percent≦b≦3.6 atomic percent; 12.5 atomic percent≦c≦14.5 atomic percent; 0 atomic percent≦d≦1.5 atomic percent; incidental impurities≦0.5 atomic percent; and residual Ni,
between two or more parts to be joined to form a joint, wherein the parts to be joined having a higher melting temperature than the braze;
heating the joint to a temperature of between 1020° C. and 1070° C.;
cooling the joint to form a brazed connection between the parts.

2. The process in accordance with claim 1, wherein the braze is inserted in the form of an amorphous ductile foil.

3. The process in accordance with claim 1, wherein the braze is inserted in the form of a paste.

4. The process in accordance with claim 1, wherein said heating the joint comprises heating to a temperature of between 1030° C. and 1060° C.

5. The process in accordance with claim 1, wherein said heating the joint comprises heating under hydrogen, inert gas, or cracked gas.

6. The process in accordance with claim 1, wherein said heating the joint comprises heating in a continuous furnace.

7. The process in accordance with claim 1, wherein the two or more parts to be joined comprise two or more parts of a heat exchanger, or an exhaust gas recirculation cooler or a metallic particle filter.

8. The process in accordance with claim 1, wherein the two or more parts to be joined comprise two or more parts made of an austenitic stainless steel or a Ni alloy or a Co alloy.

9. The process in accordance with claim 8, wherein the braze takes the form of a foil or a paste.

10. The process in accordance with claim 8, wherein brazing is carried out under hydrogen, inert gas or cracked gas.

11. The process in accordance with claim 8, wherein brazing is carried out in a continuous furnace.

12. The process in accordance with claim 8, wherein brazing is carried out at a temperature of between 1030° C. and 1060° C.

13. A brazed object, comprising a first part of the object being connected fast to a second part by a solder seam, the solder seam comprising a braze produced with a composition consisting of
NiᵣₑₛCrₐB_{b}P_{c}Si_{d}
with 20 atomic percent<a<22 atomic percent; 1.2 atomic percent≦b≦3.6 atomic percent; 12.5 atomic percent≦c≦14.5 atomic percent; 0.5 atomic percent≦d≦1.5 atomic percent; incidental impurities≦0.5 atomic percent; and residual Ni, wherein the loss of solder seam mass after ageing for 1000 hours at 70° C. in a corrosion medium with a pH value <2 and SO₄²⁻ N0₃⁻ Cl⁻ ions is less than 0.08%.

14. The brazed object in accordance with claim 13, wherein the solder seam comprises intermetallic phases comprising Cr and P and/or B which have a size d of 0 μm<d≦3 μm.

15. The brazed object in accordance with claim 14, wherein the size d of the intermetallic phases is 0.5 μm≦d≦2 μm.

16. The brazed object in accordance with claim 13, wherein the solder seam has a thickness of greater than 15 μm.

17. The brazed object in accordance with claim 13, wherein the solder seam is produced at a temperature of 1020° C. to 1070° C.

18. The brazed object in accordance with claim 13, wherein the solder seams have tensile strength that is greater than 200 MPa.

19. The brazed object in accordance with claim 13, wherein the first part and the second part each consist of a chromium-containing stainless steel.

20. The brazed object in accordance with claim 17, wherein the brazed object is a heat exchanger or an exhaust gas recirculation cooler or a metallic particle filter.

21. The process in accordance with claim 7, wherein the heat exchanger is an oil cooler.

22. The brazed object in accordance with claim 19, wherein the chromium-containing stainless steel comprises an austenitic stainless steel or Ni alloy or a Co alloy.
